(19) United States
(12) Patent Application Publication
(10) Pub. No.: US 2013/0279350 A1
(43) Pub. Date: Oct. 24, 2013

(54) Methods and Apparatus for Interference Management

(71) Applicants: Paul Erickson, Palatine, IL (US); Gerald Gutowski, Glenview, IL (US); Bishwarup Mondal, Schaumburg, IL (US); Robert Stephens, Bartlett, IL (US); Frederick Vook, Schaumburg, IL (US)

(72) Inventors: Paul Erickson, Palatine, IL (US); Gerald Gutowski, Glenview, IL (US); Bishwarup Mondal, Schaumburg, IL (US); Robert Stephens, Bartlett, IL (US); Frederick Vook, Schaumburg, IL (US)

(73) Assignee: Nokia Siemens Networks Oy

(21) Appl. No.: 13/454,594

(22) Filed: Apr. 24, 2012

(51) Int. Cl. H04W 24/00

(52) U.S. Cl. 370/252

(57) ABSTRACT

Methods and apparatus for identifying interference when prevailing conditions give rise to a suspicion of interference. Upon detection by one or more elements of a wireless network that interference may be present, measurements are directed to provide information indicating whether interference is present and whether the interference is severe enough to warrant interference mitigation. The information is analyzed to determine if severe interference is in fact present, and interference mitigation measures are directed if severe interference is identified. Analysis may include identifying one or more dominant interferers, and may further include directing additional measurements and analyzing information provided thereby in order to identify one or more dominant interferers.

### FIELD OF THE INVENTION

The present invention relates generally to wireless communication. More particularly, the invention relates to systems and techniques for management of interference in wireless networks.

### BACKGROUND

The density of wireless network users, that is, the average number of users in a particular geographic area and the data throughput required by these users, continues to increase. In one approach to serving a large number of users that may be present in a particular area, operators deploy infrastructure at least some of which has the effect of serving subregions of the area. The same operator may deploy higher power base stations serving an overall area and lower power base stations serving smaller areas overlapping the area served by the higher power base station.

All these circumstances lead to interference between base stations and user devices, and numerous interference mitigation mechanisms have been devised. However, interference mitigation typically involves some reduction in throughput for an interferer, because interference mitigation requires that interferer do something other than simply conduct its own communication at full power.

### SUMMARY

In one embodiment of the invention, an apparatus comprises at least one processor and memory storing computer program code. The computer program code is configured to, with the memory and the at least one processor, cause the apparatus to perform actions comprising at least, upon receiving information triggering a suspicion of interference affecting a user device, directing at least one measurement to provide information indicating whether interference is present, and analyzing the information provided by the at least one measurement to determine if interference is present.

In another embodiment of the invention, a method comprises configuring at least one processor to cause an apparatus to perform actions comprising at least, upon receiving information triggering a suspicion of interference affecting a user device, directing at least one measurement to provide information indicating whether interference is present, and analyzing the information provided by the at least one measurement to determine if interference is present.

In another embodiment of the invention, a computer readable medium stores a program of instructions. Execution of the program of instructions configures an apparatus to perform actions comprising at least, upon receiving information triggering a suspicion of interference affecting a user device, directing at least one measurement to provide information indicating whether interference is present, and analyzing the information provided by the at least one measurement to determine if interference is present.

These and other embodiments of the invention are described below with particularity.

### BRIEF DESCRIPTION OF THE DRAWINGS

FIG. 1 illustrates a wireless network according to an embodiment of the invention;

FIG. 2 illustrates a process according to an embodiment of the present invention; and

FIGS. 3 and 4 illustrate details of elements that may be used in carrying out at least one embodiment of the present invention.

### DETAILED DESCRIPTION

Various embodiments of the present invention recognize that numerous mechanisms exist for mitigating interference affecting a downlink transmission. Such mechanisms include inter-cell interference coordination (ICIC), use of almost blank subframes (ABS), downlink interference suppression, such as interference rejection combining (IRC) by a UE, and fractional frequency reuse (FFR). Other mechanisms include coordinated multipoint mechanisms, such as coordinated scheduling/coordinated beamforming (CS/CB) and joint transmission (JT)/joint processing (JP).

All these mechanisms are likely to have some impact on throughput for a base station, because a base station's maximum throughput can typically be achieved when it is simply transmitting to its own receiving devices without taking interference to other devices into account. There will be times when a base station is in no danger of interfering with other devices, and it is advantageous if a base station can transmit without using interference mitigation during such times.

Embodiments of the present invention therefore provide mechanisms for interference assessment based on measurements taken by a UE, so that interference mitigation can be performed when interference is determined to be present. During at least some of the times when interference is not determined to be present, or is not deemed to be of a sufficient severity to call for interference mitigation, a base station can transmit without interference mitigation.

In one or more embodiments of the invention, a suspicion of interference is triggered. Such a suspicion may be triggered, for example, by observation or detection by a UE of conditions or events that may indicate interference. Suspicion of interference may be triggered by observation or detection by an eNB of conditions or events that may indicate that one or more of its connected UEs is suffering interference.

When a suspicion of interference is triggered, one or more UE performs measurements to collect additional information about the prevailing conditions, and the information may be analyzed to determine whether or not interference is occurring, and whether the interference is sufficiently severe to call for interference mitigation measures. Measurements, and analysis of information collected during the measurements, may also identify an interferer, and may also rule out problems due to coverage. If interference is determined to present a problem, appropriate corrective actions may be taken, such as requesting base stations to perform specified interference coordination actions. Corrective measures may also include attempts to identify whether interference is being generated from a single dominant interferer. If interference originates from a single interferer, corrective measures may comprise signaling the dominant interfering cell to make appropriate corrections.

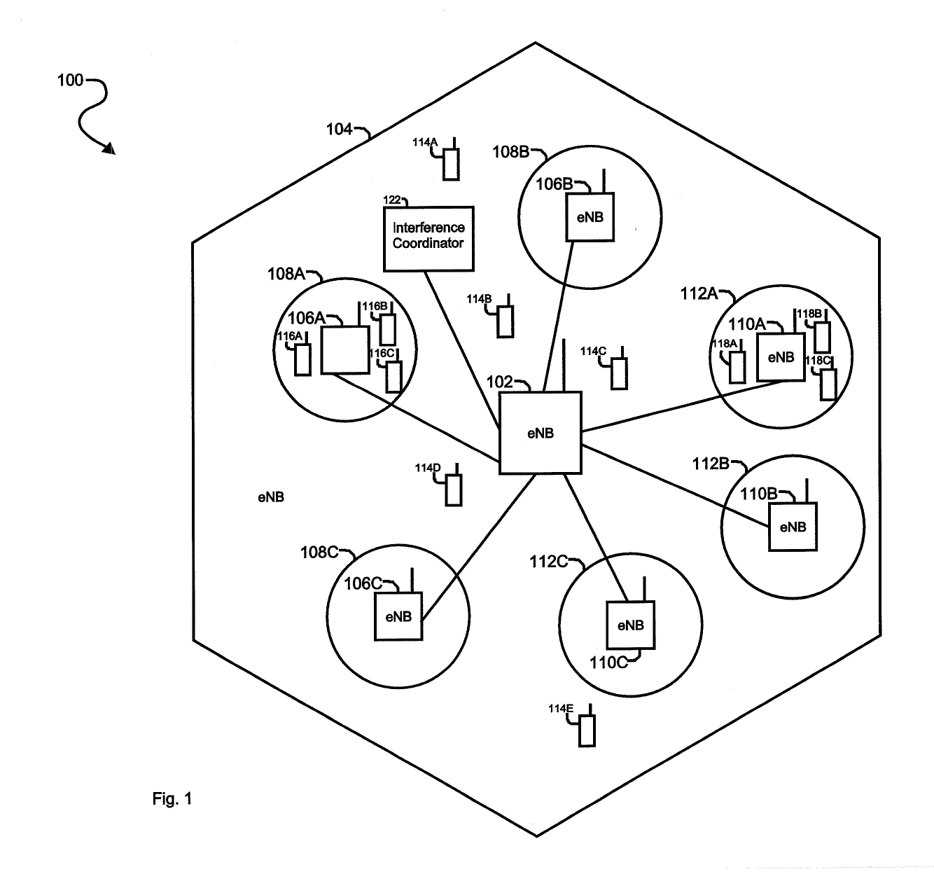

FIG. 1 illustrates a communication system 100 according to an embodiment of the present invention. The system 100 comprises a plurality of base stations, including a large high-power base station, which may suitably be implemented as an eNodeB or eNB, and which, in the context of varying types of base stations, may be referred to as a macro eNB 102. The macro eNB 102 operates at a relatively high power and provides coverage to a relatively wide geographic area, defining a cell 104. The macro eNB 102 may present significant interference to lower power transmitters. The system 100 also comprises a plurality of lower power base stations, including micro eNBs 106A-106C, serving cells 108A-108C, respectively, and pico eNBs 110A-110C, serving cells 112A-112C, respectively. The cell 104 is serving user devices, or user equipments (UEs) 114A-114E. The cell 108A is serving UEs 116A-116C and the cell 110A is serving the UEs 118A-118C.

The cell 104 overlaps all of the cells 108A-108C and the cells 112A-112C, and therefore presents a risk of significant interference to the cells with which it overlaps. The various cells 106A-106C and 110A-110C may also interfere with UEs being served by one another and with UEs being served by the macro cell 104. It will also be recognized that other operators may deploy base stations whose coverage overlaps the area illustrated here, although, for the sake of simplicity of illustration and discussion, such base stations deployed by other operators are not illustrated here.

The prospect of interference calls for various strategies to mitigate such interference, but such strategies typically require modification of the behavior of interferers, and reduce the performance of the interferers. Therefore, one or more embodiments of the present invention provide mechanisms for determining whether a communication link between a UE and an eNB is being subjected to interference and whether the interference is severe enough to warrant interference mitigation measures. For example, consider the cell 112A serving the UE 118A, with the UE 118A being attached to the eNB 110A. The UE's communication with the eNB 110A may suffer interference from a number of factors, such as cell edge interference from one of the micro cells 108A-108C or from the cell 104. Either or both of the UE 118A and the eNB 110A may monitor conditions associated with interference, and detection of particular events and conditions may trigger a suspicion of interference.

One condition that may trigger a suspicion of interference is a less than expected throughput, characterized by a higher than expected number of errors. If a downlink transmission fails a cyclic redundancy code (CRC) check, the UE will return a negative acknowledgement (Nack) to the transmitting eNB. One source of errors is interference, so that the UE 118A may, for example, monitor the number or rate of negative acknowledgements (Nacks) that it sends in response to transmissions.

Another condition associated with interference is a low received signal strength in relation to the signal being transmitted. The UE 118A may therefore measure signal to noise ratio (SINR) and a received signal strength indicator (RSSI). A relatively high RSSI detected at the same time as a relatively low SINR indicates the possibility of interference. SINR and RSSI may be measured on the common reference signal (CRS) or the channel state information reference signal (CSI-RS). To take still another example, the UE may perform neighbor cell SINR measurements on the CRS or the CSI-RS. Variations between the SINR from one cell to another may indicate the presence of interference, and may also serve to identify a dominant component to the interference.

In a further example, the UE 118A may monitor signal quality across the UE's assigned data allocation in time and frequency. Variation in signal quality, or degradation of signal quality below expected values, may indicate the presence of interference. To take another example, the UE118A may measure CSI-RS or interference measurement resources from serving and non-serving transmission points, such as from the eNB 112A as the serving transmission point and the eNBs 112B, 112C, and 104 as non-serving transmission points. The UE 118A may identify a non-serving transmission point as providing a better channel quality indication value than a serving transmission point, possibly indicating that the non-serving transmission point is a dominant interferer.

If subframe subsets, such as normal subframes and almost blank subframes, are configured for the UE, one or more of the above mechanisms may evaluated for two classifications of subframes, such as a low interference subframe and a high interference subframe. Evaluations may be performed for each type of subframe, and the results of the evaluations combined to determine if the overall results indicate the possibility of interference.

In addition to determination by the UE that interference may be present, one or more eNBs may be configured so that detection of particular events triggers a suspicion of interference by the UEs. For example, the eNB 110A may detect an excessive number of Nacks generated by the UE 118A, or in another example, the eNB 110A may become aware that the UE 118A has failed to detect an excessive number of physical downlink control channel (PDDCH) grants. As above, if subframe subsets, such as normal subframes and almost blank subframes, are configured for the UE, an eNB may perform evaluations for both types of subframes and may combine the results of the evaluations and trigger a suspicion of interference based on the combined results.

Triggering of suspicion may be based at least in part on a comparison of events or conditions against predefined thresholds. For example, to determine whether the number of Nacks is excessive, the number of Nacks may be compared against a packet error rate (PER) or a HARQ Nack rate. In addition or as an alternative, comparison may be made against parameters such as a bit error rate or a block error rate. Signal characteristics, such as SINR and RSSI, may be compared against a power threshold. Conditions may be compared against quality of service (QoS) requirement. One important threshold may be the proportion of UEs experiencing phenomena associated with interference, with the eNB triggering suspicion of interference reports associated with the possibility of interference are received from more than a specified percentage of UEs.

In one or more embodiments of the invention, a UE may be able to directly trigger a suspicion of interference based not on the observation of conditions or events, but instead based on a direct user command. For example, a UE such as the UE 118A may include an interface element allowing direct triggering of interference investigation. Such an interface element may comprise a selector, for example, comprising a hardware button or a softkey. When the user activates the selector, the UE 118A signals the eNB to which it is attached, such as the UE 110A, to inform the eNB that the user suspects an interference problem. The eNB may forward the message to an interference coordinator 122, which manages an interference identification and mitigation procedure, and may manage such procedures for multiple eNBs. The interference coordinator 122 responds to the signal by requesting the serving eNB to proceed with interference measurements with respect to the UE 118A. In one or more embodiments of the invention, the interference coordinator may lie within, or be implemented as a function of, a macro eNB. For example, a macro eNB may coordinate inter-cell interference with a pico eNB.

Once interference is suspected, appropriate interference measurements may be taken to confirm that interference exists and that the interference is sufficiently severe to call for interference mitigation measures. Measurements may be directed simply toward detecting the presence and degree of interference, or may also be directed toward identifying interferers and ruling out difficulties arising not from interference but from lack of coverage.

Approaches to interference measurement may be initiated by a UE or by an eNB. For example, once the UE 118A has detected conditions indicating possible interference, it may request information needed to take measurements to identify interference with greater certainty. In one or more embodiments of the invention, the UE requests that the eNB send a message identifying a schedule of resources that are not being used by the serving eNB, but that are being used by a neighbor cell. The message may also include information identifying a schedule of resources that are being used by neither the serving eNB nor a neighbor cell. The UE may identify unscheduled resources using a broadcast control channel, such as one defined by the IEEE 802.16e standard, and performs measurements on one or more of the unscheduled resources that it discovered. The measurements may be taken continuously, or according to a schedule or based on a triggering event. For example, a pseudo-random schedule, a predefined schedule, or a schedule based on remaining battery life may be used.

The measurements taken by the UE may comprise, for example, measuring channel quality information (CQI) to non-serving transmission points and reports identification and channel quality for interferers. The CQI measurement may include, for example, taking measurements during high-interference and low-interference subframes, if so configured. Instead of or in addition to taking measurements of channel quality information, interference may be measured based on interference measurement resources, such as physical downlink shared channel (PDSCH) holes. Measurements may include, but are not limited to, checking to determine if a cyclic prefix is present in interference data to assess the type of interference. For example, a determination may be made as to whether the interference is orthogonal frequency division multiplex (OFDM) or non-OFDM.

In one or more embodiments of the invention, an eNB, rather than a UE, determines when to send information to a UE indicating the resources on which the UE should make measurements. For example, the eNB 110A may direct multiple UEs, such as the UEs 118A-118C, to make measurements, and once the eNB 110A has received the measurements, the eNB may perform post-processing, noting the location of the UEs giving the reports, the number of UEs reporting, and the time of each report. The eNB may send information on neighbor cell CSI-RS and interference measurement REs to the UE to direct the measurements by the UEs. The measurements may be CQI measurements or pure interference reports. To take another example, the eNB may request measurements from the UE in specific time-frequency resources and in specific subframe subsets, such as low-interference or high-interference subframe subsets.

As a further alternative, or in addition, the eNB may define minimization of drive time (MDT) measurement configuration messages for UE measurements. Such messages may comprise, for example, a single point in space measurement or a time series with a specified measurement interval or GPS triggers. Alternatively or in addition, measurements may follow an operator defined procedure, which may be presented as an option, to be engaged in when specifically selected or when specified conditions are met.

Once appropriate measurements have been performed, information provided by the measurements is analyzed. At a first stage, information can be analyzed to determine whether interference is present and whether it is sufficiently severe to call for interference mitigation. Measurements taken by a UE can be analyzed to determine whether the UE is suffering interference, and measurements taken by one UE or a group of UEs can be analyzed to determine if interference is affecting the general operation of an eNB serving the UE or the group of UEs. If the analysis indicates that interference is sufficiently severe, corrective measures may be taken, such as initiating the use of almost blank subframes, initiating interference coordination, or reducing base station transmission power. Once a determination has been made to perform interference mitigation, the UE or UEs that are taking measurements to identify interference can be signaled to stop taking such measurements.

Interference mitigation may be performed for a network as a whole or for groups or categories of base stations, such as all the macro eNBs in an area in which interference is detected. However, it may be possible to identify specific interferers, and identifying an interferer or a group of interferers allows for interference mitigation to be performed for the interferers rather than including non-interfering network elements. For example, the location of a UE suffering interference can be used to determine the location at which interference is occurring, and a base station may direct measurements by a UE, or coordinate measurements by more than one UE, to determine a correspondence between interference levels and the location of a UE. By noting interference levels in relation to location, and correlating this information with the location of base stations, the location of dominant interferers can often be determined. Once a dominant interferer is identified, the interferer may be directed to take steps to reduce its interference, such as reducing power or changing scheduling allocations.

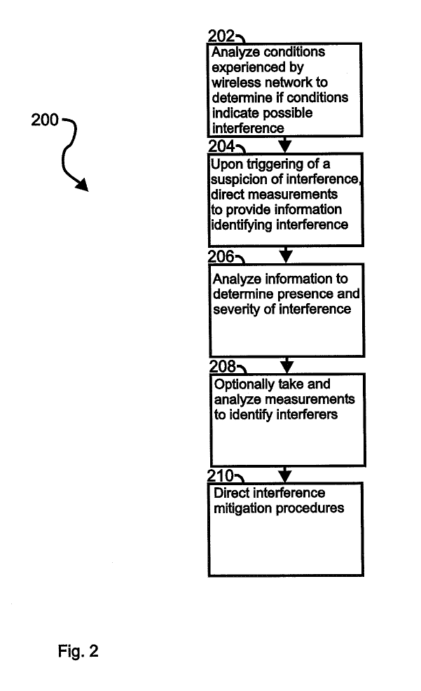

FIG. 2 illustrates a process 200 of interference detection and mitigation according to an embodiment of the present invention. At step 202, conditions experienced by wireless network elements are analyzed to determine whether the conditions indicate possible interference. At step 204, when conditions trigger a suspicion of interference, measurements are taken to provide information to determine if interference is present, and the severity of any interference. The measurements may be directed toward providing information to identify dominant interferers. At step 206, the information is analyzed to determine the presence and severity of interference, and at step 208, if interference is discovered, further measurements and analysis may be taken to identify dominant interferers. At step 210, interference mitigation measures may be taken, either for an overall network or group of base stations or for specific identified interferers.

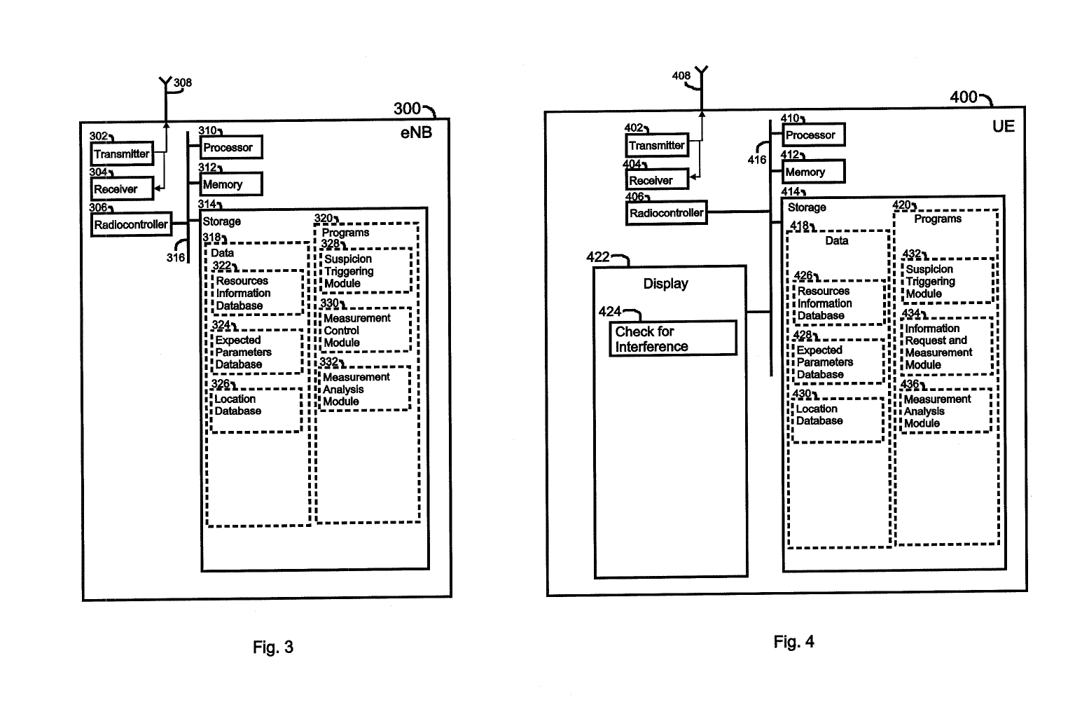

FIGS. 3 and 4 illustrate additional details of an eNodeB 300 and a UE 400 that may be configured according to, and employed in, embodiments of the present invention. An eNB similar to the eNB 300, appropriately designed and configured, may be used as a macro eNB similar to the macro eNB 102 of FIG. 1, as a micro eNB similar to the micro eNBs 106A-106C of FIG. 1, or as a pico eNB similar to the pico eNBs 110A-110C of FIG. 1.

FIG. 3 illustrates an eNodeB 300, suitably comprising a transmitter 302, receiver 304, radiocontroller 306, and antenna 308. The eNodeB 300 may also suitably comprise a processor 310, memory 312, and storage 314, suitably communicating with one another and with the radiocontroller 306 over a bus 316. The eNodeB 300 may also suitably employ data 318 and programs 320, suitably residing in storage 314 and transferred to memory 312 as needed for use by the processor 310. Among the data 318 may be, for example, a resources information database 322 for storing resource information that may be conveyed to a UE to inform the taking of measurements by the UE. Among the data 318 may also be an expected parameters database 324, for comparing measurement information reported by UEs against expected conditions, in order to analyze measurement information for interference. The expected parameters database 324 may also include information that may be used to interpret behavior of and conditions experienced by UEs and eNBs, such as failure to decode transmissions, as characterized by excessive numbers of Nacks, SINR to RSSI ratios, and other information that can be analyzed to trigger a suspicion of interference. The data 318 may also include a location database 326, that may include the locations of fixed network elements such as eNBs, and that may also be dynamically updated with location information for UEs. Among the programs 320 may be, for example, a suspicion triggering module 328 for monitoring conditions experienced by the eNB that may indicate the presence of interference, a measurement control module 330 for requesting measurements and providing information used to determine which measurements are to be taken, and a measurement analysis module 332 for analyzing measurement information and determining the presence and severity of interference and identifying interferers.

FIG. 4 illustrates a UE 400, suitably comprising a transmitter 402, receiver 404, radiocontroller 406, and antenna 408. The eNodeB 400 may also suitably comprise a processor 410, memory 412, and storage 414, suitably communicating with one another and with the radiocontroller 406 over a bus 416. The UE 400 may also suitably employ data 418 and programs 420, suitably residing in storage 414 and transferred to memory 412 as needed for use by the processor 410.

The UE 400 also comprises a display device 422, which may be implemented as a touch screen device. The display device 422 is shown here as presenting a softkey 424, to allow a user to trigger a suspicion of interference. The data 418 may comprise the UE's own resources information database 426, expected parameters database 428, and location database 430. The programs 420 may comprise the UE's own suspicion triggering module 432, as well as an information request and measurement module 434. The information request and measurement module may manage requesting information, such as from an eNB, that may be needed to select and perform needed measurements. The information request and measurement module 434 may also manage the making of measurements by the UE 400. The programs 420 may also comprise the UE's own measurement analysis module 436.

The eNB 300 and UE 400 may comprise components similar to those that are or may be used in the various similar elements discussed above. The memories 312 and 412 and storage 314 and 414 may store computer program code configured to, with their associated processors 310 and 410, cause the elements to which they belong to perform one or more of the operations as described herein.

The memory 312 and 412 and storage 314 and 414 may be of any type suitable to the local technical environment and may be implemented using any suitable data storage technology, such as semiconductor based memory devices, flash memory, magnetic memory devices and systems, optical memory devices and systems, fixed memory and removable memory. The processors 310 and 410 may be of any type suitable to the local technical environment, and may include one or more of general purpose computers, special purpose computers, microprocessors, digital signal processors (DSPs) and processors based on a multi-core processor architecture, as non-limiting examples.

Embodiments of the present invention may be implemented in software (executed by one or more processors, hardware (for example, an application specific integrated circuit), or a combination of software and hardware. In an exemplary embodiment, software is maintained on any one of various conventional computer-readable media. In the context of this document, a “computer-readable medium” may be any medium or means that can store, communicate, propagate, or transport data or instructions for use by or in connection with an instruction execution or data processing system, apparatus, or device, such as a computer, with examples of computers being depicted in FIGS. 3 and 4 and described in connection therewith. A computer readable medium may comprise a computer-readable storage medium that may be any media or means that can contain or store instructions or data for use by or in connection with an instruction execution or data processing system, apparatus, or device, such as a computer.

In general, the various embodiments of the user equipment 400 can include, but are not limited to, cellular telephones such as smart phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Various modifications and adaptations to the foregoing exemplary embodiments of this invention may become apparent to those skilled in the relevant arts in view of the foregoing description. While various exemplary embodiments have been described above it should be appreciated that the practice of the invention is not limited to the exemplary embodiments shown and discussed here.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

We claim:

1. An apparatus comprising:
at least one processor;
memory storing computer program code;
wherein the memory storing the computer program code is configured, with the at least one processor, cause the apparatus to perform actions comprising at least:
upon receiving information triggering a suspicion of interference affecting a user device, directing at least one measurement to provide information indicating whether interference is present; and
analyzing the information provided by the at least one measurement to determine if interference is present.

2. The apparatus of claim 1, wherein the actions further comprise:
upon determining that interference is present, determining if the interference is sufficiently severe to warrant interference mitigation; and
if interference is sufficiently severe to warrant interference mitigation, configuring a signal directing at least one base station to perform interference mitigation.

3. The apparatus of claim 1, wherein information triggering a suspicion of interference comprises an indication of a user selection indicating a possibility of interference.

4. The apparatus of claim 1, wherein the information triggering a suspicion of interference comprises detection of a higher than expected number of transmission errors.

5. The apparatus of claim 4, wherein detection of a higher than expected number of transmission errors comprises detection of generation of a greater than expected rate of negative acknowledgements by a user device.

6. The apparatus of claim 4, wherein detection of a higher than expected number of transmission errors comprises detection of reception of a greater than expected rate of negative acknowledgements by a user device.

7. The apparatus of claim 1, wherein information triggering a suspicion of interference comprises detection of a relatively low signal to noise ratio and a relatively high received signal strength.

8. The apparatus of claim 1, wherein the actions further comprise analyzing the information provided by the at least one measurement to identify at least one interferer.

9. The apparatus of claim 1, wherein the information provided by the at least one measurement indicates conditions experienced by a user device and also provides information indicating a location of the user device.

10. The apparatus of claim 1, wherein the actions further comprise directing at least one measurement to provide information identifying at least one interferer.

11. The apparatus of claim 1, wherein directing at least one measurement comprises directing measurements of resources used by a serving cell and one or more non-serving cells.

12. The apparatus of claim 1, wherein directing at least one measurement comprises directing measurements of unscheduled resources.

13. The apparatus of claim 1, wherein directing at least one measurement comprises directing measurements of channel quality information to non-serving transmission points.

14. The apparatus of claim 1, wherein directing at least one measurement comprises examining interference data to determine a type of interference.

15. The apparatus of claim 1, wherein directing the at least one measurement comprises directing multiple user devices attached to a base station to take measurements, and wherein analyzing the data comprises determining what proportion of the user devices attached to the base station are suffering interference.

16. A method comprising:
configuring at least one processor to cause an
apparatus to perform actions comprising at least:
upon receiving information triggering a suspicion of interference affecting a user device, directing at least one measurement to provide information indicating whether interference is present; and
analyzing the information provided by the at least one measurement to determine if interference is present.

17. The method of claim 16, wherein the actions further comprise:
upon determining that interference is present, determining if the interference is sufficiently severe to warrant interference mitigation; and
if interference is sufficiently severe to warrant interference mitigation, configuring a signal directing at least one base station to perform interference mitigation.

18. The method of claim 16, wherein information triggering a suspicion of interference comprises an indication of a user selection indicating a possibility of interference.

19. The method of claim 16, wherein the information triggering a suspicion of interference comprises detection of a higher than expected number of transmission errors.

20. A computer readable medium storing a program of instructions, execution of which by a processor configures an apparatus to perform actions comprising at least:
upon receiving information triggering a suspicion of interference affecting a user device, directing at least one measurement to provide information indicating whether interference is present; and
analyzing the information provided by the at least one measurement to determine if interference is present.
